(19) United States
(12) Patent Application Publication
(10) Pub. No.: US 2001/0047594 A1
(43) Pub. Date: Dec. 6, 2001

(54) Vibrating vacuum dryer and the related drying method

(75) Inventor: Vittoriano Marcheschi, Lappato (Lucca) (IT)

Correspondence Address: FAY, SHARPE, FAGAN, MINNICH & McKEE, LLP, Seventh Floor, 1100 Superior Avenue, Cleveland, OH, 44114-2516, US

(73) Assignee: Zanchetta & C. S.r.l.

(21) Appl. No.: 09/735,785

(22) Filed: Dec. 13, 2000

(30) Foreign Application Priority Data
Dec. 15, 1999 (IT) B099A000680

(51) Int. Cl. F26B 5/14

(52) U.S. Cl. 34/401

(57) ABSTRACT

A certain quantity of product to be dried, in powder or granular form, is sucked into a vessel located inside a vacuum container. The vessel is heated by a heat transfer fluid circulating in a gap made between an inner wall and an outer wall of the vessel. The vessel is made to vibrate by a vibrator so that the product comes constantly into contact with the heated inner wall in such a way that the product is dried.

### BACKGROUND OF THE INVENTION

The present invention relates to apparatus for drying products in powder or granular form for pharmaceutical, alimentary, chemical or similar uses.

Conventional facilities for drying granular or powder products include static ovens having a plurality of shelves designed to accommodate trays on which the moist powder or granules deriving from a manufacturing process outside the oven are placed. The moisture is evaporated by hot air circulated inside the oven.

For convenience and clarity, this description will refer to granular products only but without thereby restricting the scope of the invention, which can be applied equally effectively to the drying of powders.

Although ovens of this kind are extremely simple and economical, the product to be dried has to be manually loaded into them and manually unloaded from them at the end of the drying process. During these operations, cross contamination between the treated product and the environment is possible. Loading and unloading operations also expose operators to contact with products, which, in the case of pharmaceuticals, have a high content of active ingredients, thus creating high risks of the operators themselves being intoxicated.

Moreover, the drying cycles of these static ovens are extremely long and some cases may take several days to be completed.

Alternatively, fluid bed dryers are used instead of static ovens to dry moist granules. These dryers consist essentially of vessels housing a metallic grid or other shelf-like surface permeable to air, on which the product to be dried is placed. A flow of hot air is passed continuously over the grid in order to dry the granules. The drying times are much shorter than those of static ovens, thanks to the direct action of the air through and around the mass of granules. However, these dryers also require large volumes of hot air and this has to be suitably filtered to reduce contamination of the outside environment. This is an especially serious problem when the product to be dried contains active ingredients, as in the case of pharmaceuticals, or toxic substances, as in the case of many chemicals.

Fluid beds may be either horizontal or vertical, but whatever direction they extend in, the volume of fluid that has to be delivered is so large that fluid beds are usually enormous structures. A vertical fluid bed drier, for example, may be as high as a four-story building.

Another disadvantage of fluid bed dryers of the type described above is that the hot air flowing into and out of the vessel constitutes a substantially open circuit, despite the use of large filter bags. Hence, there is an ever present risk that that air emitted into the atmosphere is polluted by contact with the product being dried.

To overcome these disadvantages, vacuum drying containers are also used.

The vacuum eliminates the problems created by the need for large volumes of hot air and the resulting open circuit conditions, and has the advantage of permitting much smaller filters to be used.

Vacuum drying facilities have also significantly reduced drying times in relation to drying temperature because, in a vacuum, the moisture in the granules to be dried evaporates at much lower temperatures compared to fluid bed dryers where the pressure is much higher.

The vacuum is also used for feeding the moist granular product by sucking it into the vessel where a heating device raises the temperature of the granules in order to dry them. Since heating normally occurs through conduction, by heating the walls of the vessel, for example, by circulating a heat transfer fluid in appropriate gaps made in the walls of the vessel itself, the granules have to be stirred so that all of them come into contact with the hot walls uniformly.

The stirring motion is usually performed by stirring blades fixed to a rotating shaft. The disadvantage of the blades is that they may tend to grind and partly break up the moist granules. Furthermore, the use of rotating parts in a vacuum environment requires the use of suitable rotary seals which involve considerable constructional complications.

Yet another disadvantage of this type of dryer is the difficulty of cleaning the vessel not only because of the constructional complexity of the stirring blades and their drive mechanisms where dust accumulates, but also because the blades tend to smear the dust against the inside walls of the vessel.

### SUMMARY OF THE INVENTION

The aim of the present invention is to overcome the above mentioned disadvantages.

Accordingly, the present invention provides a device for drying products in powder or granular form having a vacuum container designed to hold a certain quantity of product, vacuum means for creating a vacuum inside the container, and means for heating the product, the device comprising vibrating means for vibrating the product inside the container.

The present invention also relates to a method for drying products in powder or granular form.

The present invention therefore provides a method for drying products in powder or granular form comprising the steps of feeding the product into a sealed vacuum container, heating the product and vibrating the product.

### BRIEF DESCRIPTION OF THE DRAWINGS

The invention will now be described with reference to the accompanying drawings, which illustrate preferred embodiments of it without restricting the scope of the inventive concept, and in which:

FIG. 1 is a front view of a device for drying products in powder or granular form according to the present invention;

FIG. 2 is a front view of another embodiment of the device shown in FIG. 1.

### DESCRIPTION OF THE PREFERRED EMBODIMENTS

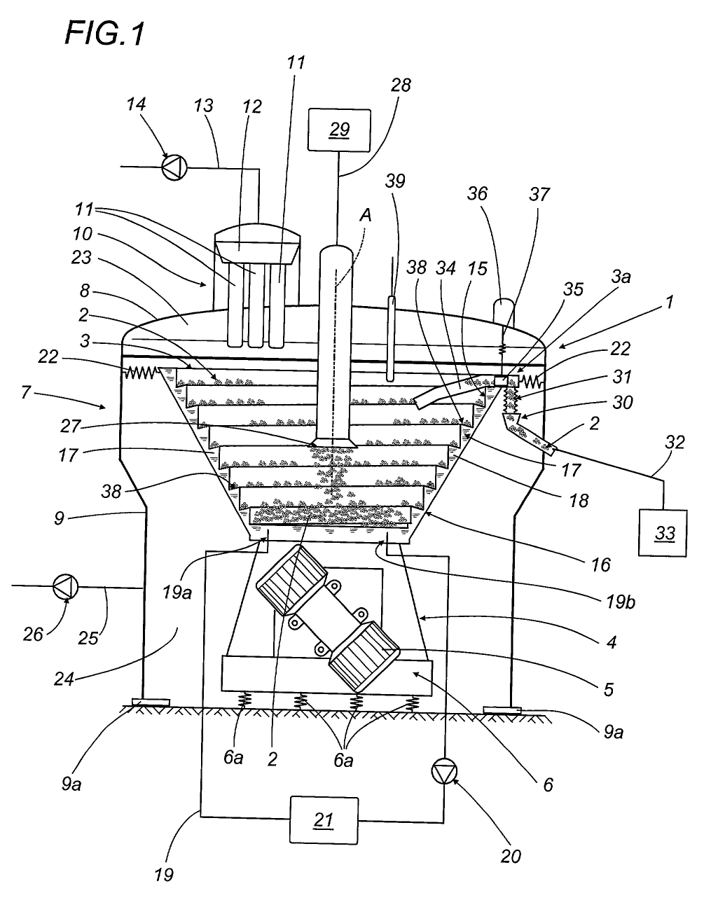

With reference to FIG. 1, the numeral 1 indicates as a whole a device for drying a product 2, in powder or granular form, inside a concave vessel 3, the bottom of which is connected to a vibrating box 4 that supports the vessel 3 itself. The box 4 is vibrated by a vibrator 5 of known type, supported by a base 6. The base 6 is connected to the floor through a plurality of vibration dampers 6a located at the bottom of the base 6 itself.

The present description will refer to a product 2 in granular form but without thereby restricting the scope of the invention, since the device 1 can be applied equally effectively to the drying of products 2 in powder form. Moist granules 2 fed into the dryer 1 are made by a granulation process performed outside the dryer 1.

As shown in FIG. 1, the vessel 3 is generally symmetrical about axis A and is housed in a sealed vacuum container 7 comprising an upper cover 8 and a lower casing 9. The lower casing 9 is generally cylindrical in shape and is connected to a base 9a.

From the cover 8 there extends a turret 10 that houses a plurality of filter bags 11 connected to a single duct 12 which is in turn connected to a pipe 13 leading to a vacuum pump 14.

The vessel 3 has a first inner wall 15 and a second outer wall 16 that form a gap 17 between them in which a heat transfer fluid 18 circulates.

The gap 17 is connected to two ends 19a and 19b of a fluid 18 circulation pipe 19. The pipe 19 is also connected to a circulation pump 20 and to a unit 21 for heating the fluid 18. Both the pump 20 and the heating unit 21 are of well known type.

An elastic diaphragm 22 joins the top outer edge of the vessel 3 to the upper end of the container 7.

The diaphragm 22 divides the interior of the container 7 into an upper compartment 23 and a lower compartment 24 in such a way that the two compartments 23, 24 do not communicate.

A pipe 25 connects the lower compartment 24 to a corresponding vacuum pump 26.

Inside the container 7, there is an outlet 27 that feeds the moist granular product 2 into the vessel 3. The outlet 27 is at one end of a pipe 28 which has at it its other end a reservoir 29 where the granular product 2 collects.

A duct 30 for collecting the dried granules 2 is located at an upper, outfeed end 3a of the vessel 3 and receives the granules 2 feeding out of the vessel 3 itself. The duct 30 communicates via a hose 31 with a pipe 32 that is connected to a storage chamber 33 for the dried granules 2.

Close to the end 3a, there is a chute 34 designed to recirculate the granules 2 inside the vessel 3.

A divert device 35, also located near the end 3a, directs the flow of dried granules 2 either towards the chute 34 for recirculation or towards the duct 30 for transfer to the storage chamber 33. A control unit 36 for controlling the divert device 35 is located on the cover 8 and is connected to the divert device 35 through a connection 37.

The inner wall 15 of the vessel 3 has a ledge 38 that extends along the axis A following a path defined by a helix whose radius increases from the bottom up.

The cover 8 of the container 7 is also fitted with a device 39 for blowing a defined volume of air into the upper compartment 23.

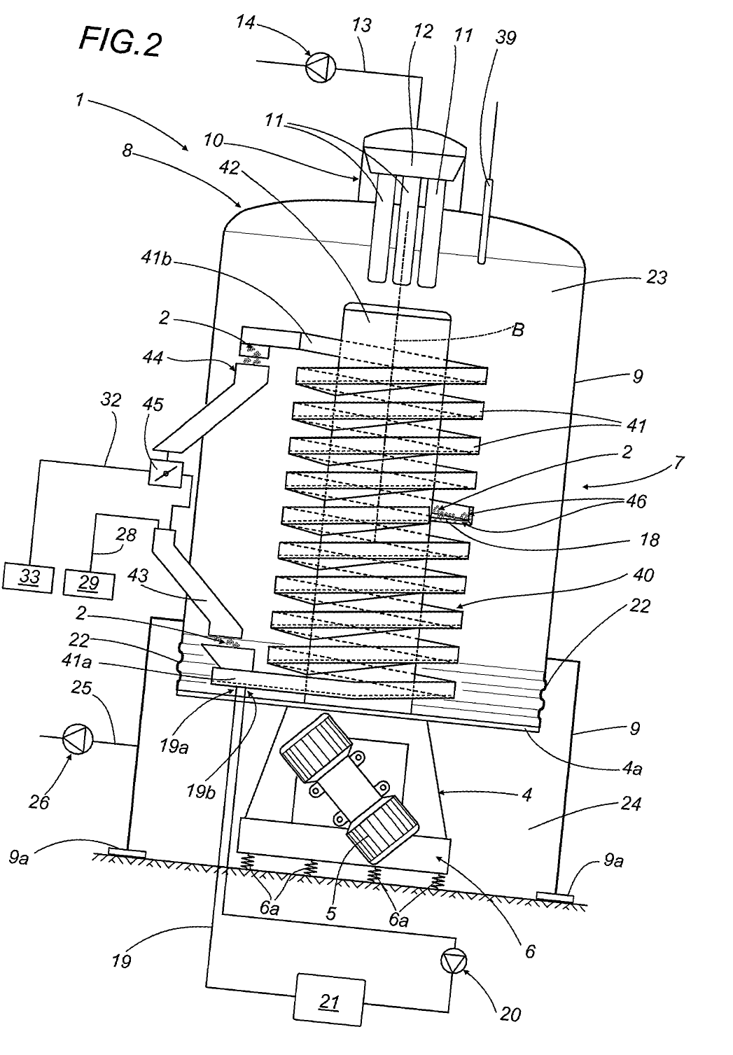

FIG. 2 shows another embodiment of the device according to the present invention. This embodiment differs from the device 1 just described, illustrated in FIG. 1, in that the container 7 houses a helical vessel 40 consisting basically of a channel 41 wound in the shape of a helix around a tubular supporting column 42 extending lengthways along an axis B.

The helical vessel 40, as in the device described above with reference to FIG. 1, is connected to the vibrating box 4.

A platform 4a, being substantially circular in shape, is attached to the vessel 3 and the vibrating box 4 at the interface between them. The platform 4a is elastically connected to the lower casing 9 of the container 7 by means of the diaphragm 22.

Close to a lower end coil 41a of the channel 41, there is an outlet 43 for feeding the product 2 to be dried into the vessel 40, said outlet 43 being connected to the feed pipe 28, whose other end, opposite the outlet 43, is connected to the reservoir 29 where the product 2 accumulates.

At an upper end coil 41b of the channel 41, opposite the coil 41a, there is a duct 44 that collects the granules 2 feeding out of the vessel 40. The duct 44 is connected to the inlet of a three-way divert valve 45, the two outlets of which are connected to the reservoir 33 where the dried granules 2 are stored and to the feed outlet 43 that recirculates the granules 2.

Inside the channel 41, substantially along its full length, there are gaps 46 through which the heat transfer fluid 18 is circulated in order to heat the granules 2 as they move along the channel 41 itself.

During use, as shown in FIGS. 1 and 2, the vacuum pump 14 sucks air out of the upper compartment 23 of the sealed container 7 to create a vacuum inside the compartment 23 itself. The air extracted from the compartment 23 is filtered by the filter bags 11 in the turret 10. At the same time, the pump 26 acts on the lower compartment 24 of the container 7 in the same way to create a vacuum in the compartment 24.

The pressure on both sides of the diaphragm 22 separating the two compartments 23 and 24 is substantially the same and the diaphragm is not subjected to deformation and keeps it elastic properties.

In the device illustrated in FIG. 1, a certain amount of granular product 2 is sucked from the reservoir 29 into the container 7 through the outlet 27 thanks to the pressure difference between the vacuum in the compartment 23 and the reservoir 29.

The moist product 2 sucked in settles inside the vessel 3, which is made to vibrate by the vibrator 5 through the vibrating box 4 to which the vessel 3 is firmly attached.

The elasticity of the diaphragm 22 is of fundamental importance since the diaphragm 22 connects the fixed container 7 to the vibrating vessel 3.

The moist granules 2 start moving up the helical ledge 38, thanks to the vibrating action and come into constant contact with the inner wall 15, heated by the heat transfer fluid 18. The granules 2 are therefore heated by the inner wall 15 through conduction.

The heating causes the granules 2 to dry by evaporating the moisture in them.

Small quantities of air are blown into the container 7 through the device 39 to improve the exchange of heat between the heated wall 15 and the moist granules 2 to be dried.

Advantageously, the vacuum considerably reduces the temperature required to evaporate any substance and, therefore, evaporation in the container 7 takes place at a much lower temperature than it would if the container remained at atmospheric pressure. As a direct consequence, the granules 2 dry much. more quickly. Furthermore, temperature-sensitive substances can be treated without being subjected to excessively high temperatures which might adversely affect them.

As mentioned above, the vibrations drive the granules 2 being dried towards the top of the vessel 3. In practice, the granules 2 move upwards along the helical path defined by the ledge 38 until they reach the upper outfeed end 3a. From the end 3a, the granules 2 fall, through the hose 31, into the duct 30 and, from there, through the pipe 32, into the storage chamber 33, from where they can be withdrawn for further processing as required. Alternatively, if the granules 2 are not completely dry when they reach the upper end 3a, the control unit 36 activates the divert device 35 which directs the granules 2 towards the chute 34 and, through this, back into the vessel 3. The granules 2 are thus recirculated so that they go through another drying cycle in the vessel 3.

Downstream of the duct 30, along the pipe 32, there is a device of the known type (not illustrated) such as a rotary or twin valve feeder, designed to enable the dried product 2 to pass from the container 7, which is under vacuum, to the storage chamber 33, where the pressure is higher. Indeed, to allow gravity feeding of the product 2, the pressure in the environment the product 2 is fed from must be the same as that it is fed to.

In the device illustrated in FIG. 2, the moist granules 2 from the reservoir 29, are fed through the outlet 43 to the lower coil 41a of the helical channel 41 in the vessel 40.

The vibrating action applied to the vessel 40 by the vibrator 5 causes the granules 2 to move up the channel 41 as far as the top coil 41b. As they move along the path, the granules 2 are heated by contact with the walls of the channel 41 which have gaps 46 made along them. The heat transfer fluid 18 is pumped through the gaps 46 by the pump 20, which is connected to the pipe 19.

When the granules 2 reach the top coil 41b, they drop into the duct 44 which communicates, downstream, with the divert valve 45. The valve 45 directs the dried granules 2 either towards the storage chamber 33 or, if drying is incomplete, towards the feed outlet 43 from where the granules 2 are recirculated in the vessel 40.

As described above with reference to FIG. 1, downstream of valve 45, on the pipe 32, there is a device of the known type (not illustrated) such as a rotary or twin valve feeder, designed to enable the dried product 2 to pass from the container 7, which is under vacuum, to the storage chamber 33, where the pressure is higher.

In other embodiments which are not illustrated, the heating of the granules 2 may be carried out using, as alternative to the heating unit 21, electricity, induction or a source of thermal radiation such as, for example, microwaves or infrared rays.

Advantageously, in another embodiment of the device for drying products 2 in granular form, the device itself performs the step of granulating the products 2. In other words, the product 2 is fed into the container 7 in powder form while binding substances are sprayed onto it, which combined with the vibrating action, turns the powder 2 into granules directly in the container 7.

The invention described can be subject to modifications and variations without thereby departing from the scope of the inventive concept. Moreover, all the details of the invention may be substituted by technically equivalent elements.

What is claimed

1. A device for drying products in powder or granular form having a sealed vacuum container designed to hold a certain quantity of product, vacuum means for creating a vacuum inside the container, and means for heating the product, the device comprising vibrating means for vibrating the product inside the container.

2. The device according to claim 1, comprising at least one vessel containing the product, the vessel being installed inside the container.

3. The device according to claim 2, wherein the vessel has at least one gap made between a first, inner wall and a second, outer wall of the vessel, the gap being designed to hold a heat transfer fluid.

4. The device according to claim 1, wherein the heating means comprise a source of thermal radiation.

5. The device according to claim 1, wherein the heating means are of the induction type.

6. The device according to claim 2, wherein the vessel has the shape of a helix.

7. The device according to claim 6, wherein the helical vessel is connected to at least one pipe in which the heat transfer fluid is circulated and which follows at least partly the same path as the helical vessel itself.

8. The device according to any of the foregoing claims from 2 to 7, wherein the vessel has a path along which the product moves, said path being in the shape of a helix around a corresponding axis.

9. The device according to any of the foregoing claims, comprising means for blowing a defined volume of air into the container.

10. The device according to claim 2, wherein the vibrating means cause the vibration of the vessel which holds the product.

11. The device according to any of the foregoing claims, wherein the container is divided into two compartments, that is to say, an upper and a lower compartment, respectively, said compartments being separated by an elastic diaphragm.

12. The device according to claim 11, wherein the pressure inside the two compartments is substantially the same.

13. The device according to claim 11, wherein the elastic diaphragm elastically connects the container to the vessel attached to the vibrating means.

14. The device according to claim 11, wherein the elastic diaphragm elastically connects the container to a platform attached to the vibrating means.

15. A method for drying product in powder or granular form, comprising the steps of feeding the product into a sealed vacuum container; heating the product; and causing the product to vibrate.

16. The method according to claim 15, comprising a step of creating a vacuum inside the container.

17. The method according to claim 16, comprising a step of aggregating the powder product into granules.
